(19) United States
(12) Patent Application Publication
(10) Pub. No.: US 2011/0261670 A1
(43) Pub. Date: Oct. 27, 2011

(54) OPTICAL PICKUP DEVICE AND OPTICAL DISC DEVICE

(75) Inventors: Hiroaki MATSUMIYA, Osaka (JP); Kazuo MOMOO, Osaka (JP)

(73) Assignee: PANASONIC CORPORATION, Osaka (JP)

(21) Appl. No.: 13/020,095

(22) Filed: Feb. 3, 2011

(30) Foreign Application Priority Data
Feb. 10, 2010 (JP) 2010-027229

(51) Int. Cl. G11B 7/00

(52) U.S. Cl. 369/103; G9B/7

(57) ABSTRACT

When recording/reproducing an information recording medium having a plurality of information recording layers, a photodetector receives reflected light from a recording layer which is being recorded/reproduced, as well as reflected light from another recording layer which is not being recorded/reproduced, making it difficult to appropriately detect control signals during a recording/reproducing operation. The present invention employs a polarization hologram element so that the polarization direction of 0^{th}-order diffracted light and that of 1^{st}-order diffracted light are made to be orthogonal to each other before light reflected from an information recording medium is incident upon the detector. Thus, it is possible to reduce the influence of interference with light from the other recording layer and to obtain appropriate control signals, thereby realizing an optical pickup device with desirable recording capability. By using the polarization hologram element so that the polarization direction of 0^{th}-order diffracted light and that of 1^{st}-order diffracted light are orthogonal to each other, it is possible to reduce the size and the thickness of an optical pickup device.

### BACKGROUND OF THE INVENTION

1. Field of the Invention

The present invention relates to an optical pickup device and an optical disc device for optically recording or reproducing information to/from an information recording medium such as an optical disc using a laser light source.

2. Description of the Related Art

In recent years, high-density and large-capacity optical discs such as DVDs and next-generation high-density optical discs have been commercialized, and have been widespread as recording media capable of handling large amounts of information such as videos. Optical pickup devices for reliably recording and reproducing information to/from high-density and large-capacity optical discs have been proposed in the art (see, for example, Japanese Laid-Open Patent Publication No. 2004-281026). In recent years, optical discs having a plurality of recording layers have been proposed in the art in order to further increase the recording capacity per optical disc.

An example of an optical pickup device for recording and reproducing information to/from such an optical disc having a plurality of recording layers will be described with reference to FIGS. 10 to 14. The optical pickup device shown in FIG. 10 is capable of recording/reproducing an optical disc 1206 having two information recording layers of a first information recording layer 1206a and a second information recording layer 1206b. FIG. 11 shows a configuration of an optical system 1012 of an optical pickup device. In the optical system 1012, a light beam emitted from a laser light source 1201 passes through a beam splitter 1203, a collimator lens 1204 and an object lens 1205 to form a light spot on the first information recording layer 1206a of the optical disc 1206. It is assumed at this point that the focus is on the first information recording layer 1206a. The light beam reflected by the first information recording layer 1206a of the optical disc 1206 passes through the object lens 1205 and the beam splitter 1203 to be incident upon a diffraction element 1202, and passes through a detection lens 1207 to be incident upon a photodetector 1208.

FIG. 12 shows a configuration of the diffraction element 1202, which is divided into seven regions 1030a, 1030b, 1030c, 1030d, 1030e, 1030f and 1030g. A region 1300 includes the regions 1030a, 1030b, 1030c, 1030d, 1030e, 1030f and 1030g, and is generally equal to the shape of the entire light beam incident upon the diffraction element 1202. Note that the center of the region 1300 generally coincides with an optical axis 1020 of the optical system 1012 shown in FIG. 11.

The regions 1030c, 1030d, 1030e and 1030f are regions that receive only 0^{th}-order diffracted light not reflected by the shape of the track in the first information recording layer 1206a of the optical disc 1206, the regions 1030a and 1030b are regions where 1^{st}-order diffracted light reflected by the shape of the track in the first information recording layer 1206a of the optical disc 1206 and the 0^{th}-order diffracted light overlap with each other.

FIGS. 13 and 14 show the detailed configuration of the photodetector 1208. The photodetector 1208 includes the photodetection sections 1040a, 1040b, 1040c, 1040d, 1040e, 1040f, 1040g and 1040h, and outputs an electric signal, through photoelectric conversion, in accordance with the intensities of light received by the photodetection sections.

A light spot 1400 incident upon the photodetection sections 1040a, 1040b, 1040c and 1040d shown in FIG. 13 corresponds to the 0^{th}-order diffracted light through the region 1300 of the diffraction element 1202, and the light spots 1041a and 1041b incident upon the photodetection sections 1040e and 1040f correspond to the 1^{st}-order diffracted light through the regions 1030a and 1030b, respectively.

Moreover, the light spot 1041ef incident upon the photodetection section 1040g is the 1^{st}-order diffracted light through the regions 1030e and 1030f overlapping with each other, and the light spot 1041cd incident upon the photodetection section 1040h is the 1^{st}-order diffracted light through the regions 1030c and 1030d overlapping with each other.

Note that the settings are such that the 1^{st}-order diffracted light through the region 1030g is incident upon positions away from any of the photodetection sections 1040a, 1040b, 1040c, 1040d, 1040e, 1040f, 1040g and 1040h and not incident upon these photodetection sections.

The photodetection sections 1040a, 1040b, 1040c, 1040d, 1040e, 1040f, 1040g and 1040h output signals A, B, C, D, E, F, G and H, respectively. A tracking error signal TE and a focus error signal FE are produced through calculations with these signals A-H.

FE is detected by a known astigmatism method, and an FE and RF signal calculation circuit 1504 shown in FIG. 14 performs calculations of Expressions 1 and 2 based on the signals A-D to produce the focus error signal FE and an information signal RF.

FE=(A+C)−(B+D) Expression 1

RF=A+B+C+D Expression 2

A TE main signal MTE produced by a TE main signal calculation circuit 1501 is a tracking error signal by a known push-pull method, and is calculated as shown in Expression 3 by the TE main signal calculation circuit 1501. A TE sub-signal calculation circuit 1502 calculates a TE sub-signal STE as shown in Expression 4, and a TE signal calculation circuit 1503 performs the calculation of the tracking error signal TE of Expression 5.

MTE=E−F Expression 3

STE=H−G Expression 4

TE=MTE−α×STE (α is a constant) Expression 5

A signal calculation circuit 1505 outputs the signal obtained by Expressions 1-5 above to an object lens driving device control circuit 1101 shown in FIG. 10 to control an object lens driving device 1102 and drive an actuator 1103, thereby performing tracking and focusing control operations of moving the object lens 1205 in the thickness direction and the radial direction of the optical disc 1206.

### SUMMARY OF THE INVENTION

Although a case where the focus is on the first information recording layer 1206a, of the two information recording layers 1206a and 1206b, of the optical disc 1206 shown in FIG. 10 has been described above, there is at the same time light that passes through the first information recording layer 1206a to be incident upon and reflected by the second information recording layer 1206b in a defocused state. Therefore, 0^{th}-order diffracted light and 1^{st}-order diffracted light that are produced by being reflected by the second information recording layer 1206b to be incident upon the diffraction element 1202 through the object lens 1205 and the beam splitter 1203 pass through the detection lens 1207 to be incident upon the photodetector 1208 in a significantly defocused state.

Light spots 1410, 1042a, 1042b, 1042c, 1042d, 1042e and 1042f indicated by chain lines in FIG. 13 are light spots of reflected light from the second information recording layer 1206b of the optical disc 1206 having been diffracted by the diffraction element 1202. The light spot 1410 is 0^{th}-order diffracted light through the region 1300 of the diffraction element 1202, and the light spots 1042a, 1042b, 1042c, 1042d, 1042e and 1042f are 1^{st}-order diffracted light through the regions 1030a, 1030b, 1030c, 1030d, 1030e and 1030f, respectively.

The light spot 1410 which is 0^{th}-order diffracted light through the diffraction element 1202 is incident upon the photodetector 1208 in a defocused state so as to be incident upon all of the photodetection sections 1040a, 1040b, 1040c, 1040d, 1040e, 1040f, 1040g and 1040h of the photodetector 1208.

Typically, light emitted from a semiconductor laser as the laser light source 1201 is a bundle of linearly-polarized light beams aligned together in a predetermined direction, and it is assumed that light emitted from the laser light source is polarized in a direction along the Y axis in FIG. 11.

That is, light emitted from the laser light source 1201 is incident upon the beam splitter 1203 while maintaining its polarization direction. Light reflected by the beam splitter 1203 and traveling toward the optical disc 1206 maintains the polarization direction along the Y axis, and is condensed onto the optical disc 1206 through the collimator lens 1204 and the object lens 1205. Light reflected by the optical disc 1206 passes through the object lens 1205, the collimator lens 1204 and the beam splitter 1203 to be incident upon the diffraction element 1202 while maintaining the polarization direction along the Y axis, as does the incident light. The light passes through the detection lens 1207 to be incident upon the detector 1208 with no conversion of polarization of the 0^{th}-order diffracted light and 1^{st}-order diffracted light produced.

Therefore, the light spot 1400 formed by the reflected light from the first information recording layer 1206a of the optical disc 1206 and the light spot 1410 formed by the reflected light from the second information recording layer 1206b have the same polarization direction along the Y-axis direction.

In a case where there are a plurality of light beams of different polarization directions, light beams of the same polarization direction interfere with each other. If there is this interference between light beams, there occurs superposition of light intensities depending on the phases of the light beams at the point of observation. That is, their light intensities add up together if they are in phase, for example, and their light intensities are canceled out by each other if they are in reverse phases, resulting in an increase/decrease of light intensity.

Thus, on the photodetection sections 1040a, 1040b, 1040c and 1040d, the light spot 1400 of 0^{th}-order diffracted light produced by the light reflected by the first information recording layer 1206a to be incident upon the diffraction element 1202 interferes with a portion of the light spot 1410 of the 0^{th}-order diffracted light produced by the light reflected by the second information recording layer 1206b to be incident upon the diffraction element 1202, thereby resulting in an increase/decrease of light intensity.

Moreover, on the photodetection sections 1040e, 1040f, 1040g and 1040h, the light spots 1041a, 1041b, 1041ef and 1041cd of 1^{st}-order diffracted light produced by the light reflected by the first information recording layer 1206a to be incident upon the diffraction element 1202 interfere with a portion of the light spot 1410 produced by the light reflected by the second information recording layer 1206b to be incident upon the diffraction element 1202, thereby resulting in an increase/decrease of light intensity.

Light emitted from a semiconductor laser which forms the laser light source 1201 typically has a continuous light intensity distribution such that the light intensity, highest at the center, gradually decreases away from the center, and the continuous light intensity distribution is maintained for the light spot incident upon the photodetector 1208 which is produced by the diffraction grating 1202 after the light is condensed onto and reflected by the optical disc 1206.

However, with a conventional optical pickup device, optical interference occurs between the light spots 1400, 1041a, 1041b, 1041ef and 1041cd on the photodetection sections 1040a, 1040b, 1040c, 1040d, 1040e, 1040f, 1040g and 1040h, and the phase relationships between interfering light beams are irregular and discontinuous, thereby resulting in an irregular and discontinuous increase/decrease of light intensity. As a result, the light intensity distribution among the light spots detected by the photodetection sections 1040a, 1040b, 1040c, 1040d, 1040e, 1040f, 1040g and 1040h is irregular and discontinuous, as opposed to the light intensity distribution among the light spots 1400, 1041a, 1041b, 1041ef and 1041cd.

The conventional optical pickup device has such a configuration that a stable tracking control and focusing control can be performed by using TE and FE produced based on Expressions 1-5, by using a light spot of light which has been reflected by an information recording layer of an optical disc and diffracted through the diffraction element 1202, which has the above-described continuous light intensity distribution such that the light intensity, highest at the center, gradually decreases away from the center.

However, since optical interference occurs between the light spots 1041a, 1041b, 1041ef and 1041cd incident upon the photodetection sections 1040e, 1040f, 1040g and 1040h, resulting in an irregular and discontinuous light intensity distribution, it is not possible to appropriately obtain the signals MTE, STE and TE produced based on Expressions 3-5 by detecting light spots of light reflected by the first information recording layer 1206a and diffracted through the diffraction element 1202.

On the other hand, since the light spot 1410 of reflected light from the second information recording layer 1206b is incident upon the photodetection sections 1040a, 1040b, 1040c, 1040d, 1040e, 1040f, 1040g and 1040h in a defocused state, the light intensity thereof is smaller than the light intensity of the light spot 1400 which is the reflected light from the first information recording layer 1206a, and the magnitude of the increase/decrease of light intensity occurring due to interference between these light beams on the photodetection sections 1040a, 1040b, 1040c and 1040d is sufficiently small. Therefore, it only has a small influence on the continuity of the light intensity distribution, and it is possible to appropriately obtain the signals FE and RF produced based on Expressions 1 and 2 by the light spot 1400 which is reflected light from the first information recording layer 1206a.

This is so because of the following reason. With the conventional optical pickup device, the diffraction efficiency of the diffraction element 1202 for 0^{th}-order diffracted light and that for 1^{st}-order diffracted light are set to 80% and 8%, respectively, so that the light intensity ratio between the 0^{th}-order diffracted light and the 1^{st}-order diffracted light is about 10:1. In such a case, the proportion of the light intensity of the light spot 1400 (which is the 0^{th}-order diffracted light through the diffraction element 1202 of reflected light from the first information recording layer 1206a) with respect to the light intensity of the light spot 1410 (which is the 0^{th}-order diffracted light through the diffraction element 1202 of reflected light from the second information recording layer 1206b) shown in FIG. 13 is about 1/10 the proportion of light intensity of the light spots 1041a, 1041b, 1041ef and 1041cd incident upon the photodetection sections 1040e, 1040f, 1040g and 1040h.

That is, the influence of the irregular and discontinuous increase/decrease of light intensity occurring due to interference between these light beams on the light intensity distribution of the light spots 1041a, 1041b, 1041ef and 1041cd is about 10 times greater than the influence on the light intensity distribution of the light spot 1400.

Therefore, with the conventional optical pickup device, although the focus error signal FE and the information signal RF can be produced appropriately, the TE main signal MTE and the TE sub-signal SFE are inaccurate. Thus, since it is not possible to obtain appropriate control signals for producing the tracking error signal TE based on Expression 5, the recording/reproducing capability deteriorates.

Note that although the light spots 1042a, 1042b, 1042c, 1042d, 1042e and 1042f of 1^{st}-order diffracted light through the diffraction element 1202 of reflected light from the second information recording layer 1206b are also incident upon the photodetector 1208 as described above, they arrive at positions distant from the photodetection sections 1040a, 1040b, 1040c, 1040d, 1040e, 1040f, 1040g and 1040h as shown in FIG. 13 and are not incident upon these photodetection sections. Therefore, they do not need to be taken into consideration.

It is possible, in order to avoid this influence, to increase the distance between the photodetection sections 1040e, 1040f, 1040g and 1040h and the photodetection sections 1040a, 1040b, 1040c and 1040d shown in FIG. 13 so that the light spot 1410 of the 0^{th}-order diffracted light through the diffraction element 1202 of reflected light from the second information recording layer 1206b is not incident upon the photodetection sections 1040e, 1040f, 1040g and 1040h. In such a case, however, the area of the photodetector 1208 increases, thereby hindering a reduction in size of the photodetector 1208, and thus making it difficult to reduce the size/thickness of the optical pickup device.

Japanese Laid-Open Patent Publication No. 2009-009628 discloses an optical pickup device in which a ½-wave plate is added between the diffraction element and the photodetector on the return path, so that the polarization direction of the 0^{th}-order diffracted light and that of the 1^{st}-order diffracted light are made to be orthogonal to each other by the use of the ½-wave plate. With this method, the polarization direction of the light spot 1410 of 0^{th}-order diffracted light and that of the light spots 1041a, 1041b, 1041ef and 1041cd of 1^{st}-order diffracted light shown in FIG. 13 can be made to be orthogonal to each other, thereby reducing the interference therebetween. However, the configuration disclosed in Japanese Laid-Open Patent Publication No. 2009-009628 requires the addition of a ½-wave plate between the diffraction element and the photodetector, thereby increasing the number of components, and making it difficult to reduce the size/thickness of the optical pickup device. As the number of optical elements increases, a higher precision is required for the alignment between the optical elements, thus increasing the manufacturing cost. Since the reflected light is diffracted and fanned out through the diffraction element, it is necessary to increase the area of the ½-wave plate for the fanned-out reflected light. Since the alignment is made more difficult as described above, it is necessary for ensuring a margin to also increase the size of the detection lens 1207 and the photodetector 1208 downstream along the path, thereby increasing the size of the optical pickup device.

The present invention has been made in view of the problems described above, and an object thereof is to provide a small optical pickup device capable of reliably reading out information from an optical disc having a plurality of recording layers therein, and an optical disc device having the same.

An optical pickup device of the present invention includes: a light source for emitting light; an object lens for condensing the light onto an optical disc; a polarization hologram element for diffracting reflected light reflected by the optical disc; a first photodetection section for detecting 0^{th}-order diffracted light produced by the diffraction; and a second photodetection section for detecting 1^{st}-order diffracted light produced by the diffraction, wherein the polarization hologram element diffracts the reflected light so that an optical polarization direction of the 0^{th}-order diffracted light incident upon the first photodetection section and an optical polarization direction of the 1^{st}-order diffracted light incident upon the second photodetection section are orthogonal to each other.

In one embodiment, the optical pickup device further includes: a beam splitter for changing a direction of the light emitted from the light source, wherein a polarization direction of the light emitted from the light source and incident upon the beam splitter is inclined with respect to a surface of the beam splitter that is closer to the optical disc on an optical path.

In one embodiment, the optical pickup device further includes: a beam splitter for changing a direction of the light emitted from the light source; and a switching section for rotating the light source so as to switch, from one to another, an angle between a polarization direction of the light emitted from the light source and incident upon the beam splitter and a direction of a surface of the beam splitter that is closer to the optical disc on an optical path.

In one embodiment, the switching section switches the angle from one to another when recording information to the optical disc and when reproducing information from the optical disc.

In one embodiment, the switching section switches the angle from one to another so that the angle during the recording operation is larger than that during the reproducing operation.

In one embodiment, the polarization hologram element is placed closer to an adjacent downstream optical element than to an adjacent upstream optical element along an optical path.

In one embodiment, the polarization hologram element includes: a birefringent substrate; and a diffraction grating provided on the substrate.

In one embodiment, the polarization hologram element includes a birefringent layer provided with a diffraction grating.

In one embodiment, the optical pickup device further includes a diffracted light intensity ratio setting section for setting a light intensity ratio between the 0^{th}-order diffracted light and the 1^{st}-order diffracted light produced by the polarization hologram element to a predetermined value.

In one embodiment, the diffracted light intensity ratio setting section is a polarization control section for controlling a polarization direction of light to be incident upon the polarization hologram element.

In one embodiment, the polarization control section is a wave plate.

In one embodiment, the diffracted light intensity ratio setting section sets a predetermined angle between an optically-anisotropic axis direction of a birefringent member of the polarization hologram element and a grating direction of a diffraction grating of the polarization hologram element.

In one embodiment, the first photodetection section detects the 0^{th}-order diffracted light which is incident thereupon through a first analyzer; and the second photodetection section detects the 1^{st}-order diffracted light which is incident thereupon through a second analyzer.

In one embodiment, a light intensity ratio between the 0^{th}-order diffracted light and the 1^{st}-order diffracted light is switched between a plurality of values by using the diffracted light intensity ratio setting section.

An optical disc device of the present invention is an optical disc device having the optical pickup device set forth above, including: a first calculation section for producing a focus error signal based on light received by the first photodetection section; a second calculation section for calculating a differential output obtained from an amount of light detected by the second photodetection section so as to produce at least a portion of a tracking error signal; and a control section for performing a focusing control and a tracking control by using the signals calculated by the first and second calculation sections.

According to the present invention, the polarization hologram element is used to diffract the reflected light so that the polarization direction of the 0^{th}-order diffracted light to be incident upon the first photodetection section and the polarization direction of the 1^{st}-order diffracted light to be incident upon the second photodetection section are orthogonal to each other. Therefore, even if the 0^{th}-order diffracted light diffracted through the polarization hologram element is incident upon the second photodetection section, the interference between the 1^{st}-order diffracted light and the 0^{th}-order diffracted light incident upon the second photodetection section can be reduced. Thus, the distance between the first photodetector and the second photodetector can be set to be small, and it is possible to reduce the size and the thickness of an optical pickup device.

Where information is read out from an optical disc having a plurality of recording layers as in the present invention, reflected light from a layer different from the target layer from which information is being read out causes problems. As described above, the reflected light from a different layer is, for example, the light spot 1410 shown in FIG. 14. According to the present invention, it is possible to reduce interference with such a light spot, and it is therefore possible to reduce the size of the photodetector and thus to reduce the size of the optical pickup.

According to the present invention, the polarization hologram element is used to produce 0^{th}-order diffracted light and 1^{st}-order diffracted light whose polarization directions are orthogonal to each other. Therefore, it is possible to reduce the number of optical elements, and to reduce the size and the thickness of an optical pickup device. Since the number of optical elements is small, the step of aligning optical elements with one another in the manufacturing process is facilitated, thereby allowing for a reduction in the manufacturing cost. With the alignment facilitated, it is possible to ensure a margin even if the size of the detection lens and the photodetector downstream along the path is reduced, and it is therefore possible to reduce the size and the thickness of an optical pickup device.

According to the present invention, the polarization direction of light emitted from the light source and incident upon the beam splitter is inclined with respect to the surface of the beam splitter that is closer to the optical disc on the optical path, thereby making it possible to set the light intensity ratio between the 0^{th}-order diffracted light and the 1^{st}-order diffracted light to an intended ratio.

According to the present invention, the angle between the polarization direction of light emitted from the light source and incident upon the beam splitter and the direction of the surface of the beam splitter that is closer to the optical disc on the optical path is switched from one to another. Thus, it is possible to set the most suitable light intensity ratio for each operating condition. For example, during a recording operation, the light source can be rotated so that the angle is larger than that during a reproducing operation, thereby increasing the light intensity ratio for the 1^{st}-order diffracted light. Thus, the tracking error signal can be increased, and it is therefore possible to realize a control with the amount of off-track reduced, which is important during a recording operation, thus obtaining more desirable recording capability. By decreasing the angle during a reproducing operation, it is possible to increase the light intensity ratio for the 0^{th}-order diffracted light. Since a large light intensity is needed for the 0^{th}-order diffracted light which is the information signal when reproducing an optical disc, it is possible to realize desirable reproducing capability by setting the light intensity ratio for the 0^{th}-order diffracted light to a large value during a reproducing operation.

As a predetermined angle is set, with the diffracted light intensity ratio setting section, between the crystal axis direction of the birefringent substrate of the polarization hologram element and the grating direction of the diffraction grating, it is possible to stably detect control signals such as tracking error signals and focus error signals, thereby realizing desirable recording/reproducing capability.

The first photodetection section may detect the 0^{th}-order diffracted light which is incident thereupon through the first analyzer, and the second photodetection section may detect the 1^{st}-order diffracted light which is incident thereupon through the second analyzer. Then, it is possible to optically separate the 0^{th}-order diffracted light and the 1^{st}-order diffracted light from each other and to detect them individually, and it is therefore possible to even more stably detect control signals, thereby realizing desirable recording/reproducing capability.

### BRIEF DESCRIPTION OF THE DRAWINGS

FIG. 1 is a diagram showing an optical pickup device according to Embodiment 1 of the present invention.

FIG. 2 is a diagram showing an optical system of the optical pickup device according to Embodiment 1 of the present invention.

FIG. 3 is a diagram showing a polarization hologram surface of the optical pickup device according to Embodiment 1 of the present invention.

FIG. 4A is a diagram showing a photodetector of the optical pickup device according to Embodiment 1 of the present invention.

FIG. 4B is a diagram showing a photodetector of the optical pickup device according to Embodiment 1 of the present invention.

FIG. 5 is a diagram showing the relationship between the polarization direction of light emitted from a laser light source and the beam splitter according to Embodiment 1 of the present invention.

FIGS. 6(a) to 6(c) are graphs showing the concept of how the offset amounts of the signals MTE, STE and TE change when the object lens of Embodiment 1 of the present invention is deflected.

FIGS. 7(a) and 7(b) are cross-sectional views showing a polarization hologram element of the optical pickup device according to Embodiment 1 of the present invention.

FIG. 8 is a diagram showing an optical system of the optical pickup device according to Embodiment 1 of the present invention.

FIG. 9 is a diagram showing a photodetector of the optical pickup device according to Embodiment 2 of the present invention.

FIG. 10 is a diagram showing an optical pickup device.

FIG. 11 is a diagram showing an optical system of an optical pickup device.

FIG. 12 is a diagram showing a diffraction element of an optical pickup device.

FIG. 13 is a diagram showing a photodetector of an optical pickup device.

FIG. 14 is a diagram showing a photodetector of an optical pickup device.

### DETAILED DESCRIPTION OF PREFERRED EMBODIMENTS

### Embodiment 1

An optical pickup device according to Embodiment 1 of the present invention will be described with reference to FIGS. 1 to 4B.

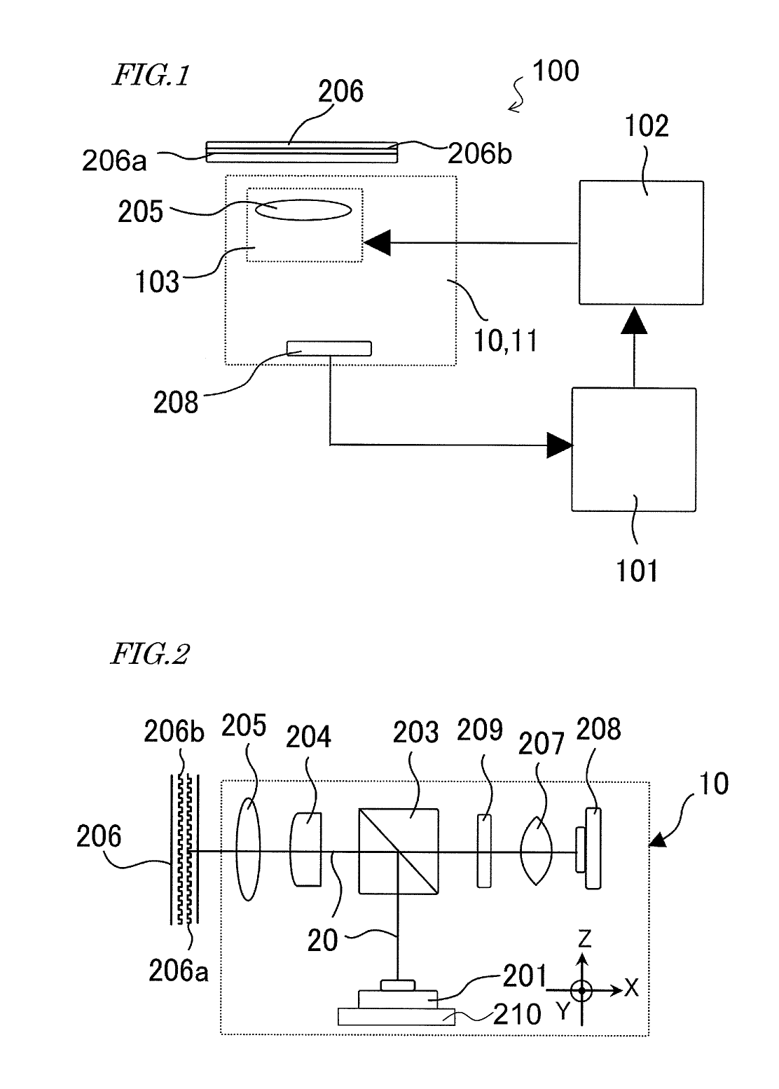

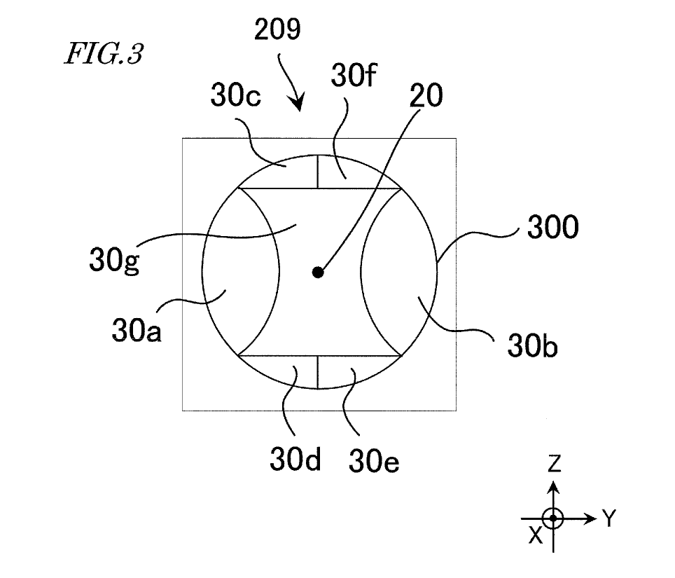

FIG. 1 is a diagram showing an optical pickup device 100 according to Embodiment 1 of the present invention. The optical pickup device 100 is capable of recording/reproducing an optical disc 206 having two information recording layers of a first information recording layer 206a and a second information recording layer 206b. FIG. 2 shows in detail an optical system configuration 10 of the optical pickup device shown in FIG. 1. Referring to FIG. 2, a light beam emitted from a laser light source 201 passes through a beam splitter 203, a collimator lens 204 and an object lens 205 to form a light spot on the first information recording layer 206a of the optical disc 206. It is assumed at this point that the focus is on the first information recording layer 206a. The light beam reflected by the first information recording layer 206a of the optical disc 206 passes through the object lens 205, the beam splitter 203 and a detection lens 207 to be incident upon a polarization hologram element 209, and passes through the detection lens 207 to be incident upon a photodetector 208.

FIG. 3 shows a configuration of the polarization hologram element 209, which is divided into seven regions 30a, 30b, 30c, 30d, 30e, 30f and 30g. A region 300 includes the regions 30a, 30b, 30c, 30d, 30e, 30f and 30g, and is generally equal to the shape of the entire light beam incident upon the polarization hologram element 209.

The regions 30c, 30d, 30e and 30f are regions that receive only 0^{th}-order diffracted light not reflected by the shape of the track in the first information recording layer 206a of the optical disc 206, the regions 30a and 30b are regions where 1^{st}-order diffracted light reflected by the shape of the track in the first information recording layer 206a of the optical disc 206 and the 0^{th}-order diffracted light overlap with each other. Note that the center of the region 300 generally coincides with an optical axis 20 of the optical system 10 shown in FIG. 2.

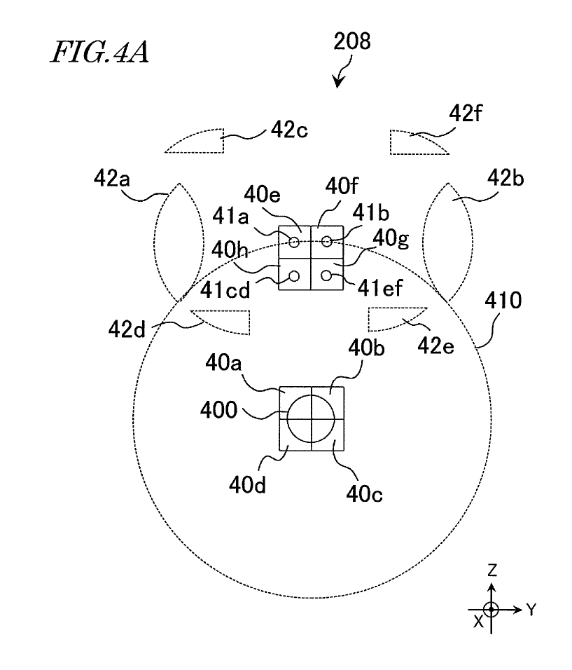

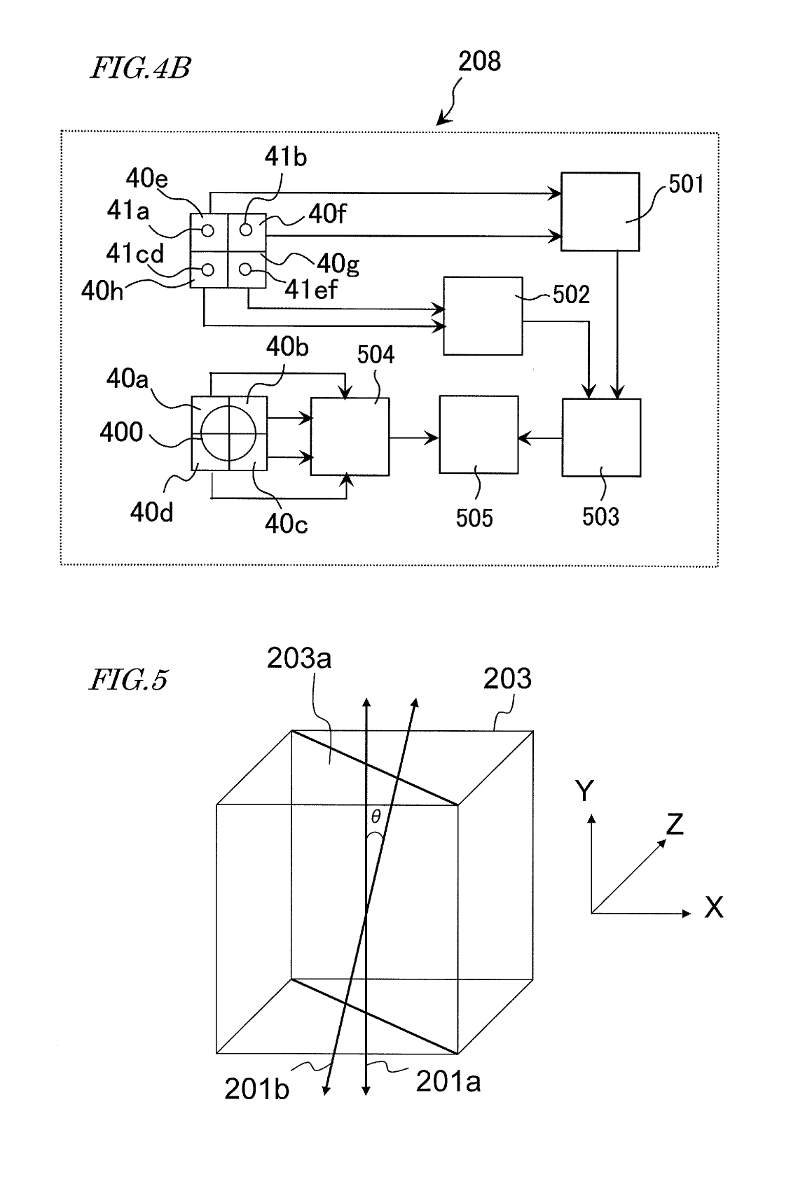

FIGS. 4A and 4B show the detailed configuration of the photodetector 208. The photodetector 208 includes the photodetection sections 40a, 40b, 40c, 40d, 40e, 40f, 40g and 40h, and outputs an electric signal, through photoelectric conversion, in accordance with the intensities of light received by the photodetection sections.

The photodetection sections 40a, 40b, 40c and 40d shown in FIG. 4A detect a light spot 400 of 0^{th}-order diffracted light through the region 300 of the polarization hologram element 209, and the photodetection sections 40e and 40f detect light spots 41a and 41b of 1^{st}-order diffracted light through the regions 30a and 30b, respectively. Moreover, the photodetection section 40g detects a light spot 41ef which is produced as beams of 1^{st}-order diffracted light through the regions 30e and 30f overlap with each other, and the photodetection section 40h detects a light spot 41cd which is produced as beams of 1^{st}-order diffracted light through the regions 30c and 30d overlap with each other.

Note that the settings are such that the 1st-order diffracted light through the region 30g is incident upon positions away from any of the photodetection sections 40a, 40b, 40c, 40d, 40e, 40f, 40g and 40h and not incident upon these photodetection sections.

The photodetection sections 40a, 40b, 40c, 40d, 40e, 40f, 40g and 40h output signals A, B, C, D, E, F, G and H, respectively. A tracking error signal TE and a focus error signal FE are produced through calculations with these signals A-H.

FE is detected by a known astigmatism method, and an FE and RF signal calculation circuit 504 shown in FIG. 4B produces the focus error signal FE and the information signal RF based on the signals A-D and outputs the produced signals to a signal calculation circuit 505.

FE=(A+C)−(B+D) Expression 6

RF=A+B+C+D Expression 7

A TE main signal MTE produced by a TE main signal calculation signal 501 is a tracking error signal by a known push-pull method, and is calculated as shown in Expression 8 by the TE main signal calculation signal 501. A TE sub-signal calculation circuit 502 calculates the TE sub-signal STE based on Expression 9, and the calculation of the tracking error signal TE of Expression 10 (differential output calculation) is performed by a TE signal calculation circuit 503.

MTE=E−F Expression 8

STE=H−G Expression 9

TE=MTE−α×STE (α is a constant) Expression 10

A method for setting the constant α of Expression 10 will now be described.

An object lens driving device control circuit 101 controls an object lens driving device 102 based on the focus error signal FE output from the signal calculation circuit 505 to drive an actuator 103, thereby displacing the object lens 205 by a predetermined distance in the radial direction of the optical disc 206 while light emitted from the laser light source 201 forms a condensed spot on the first information recording layer 206a.

Since the laser light emitted from the light source 201 typically exhibits a non-uniform intensity distribution such that the intensity is high near the axis and decreases away from the optical axis, the intensity distribution of the light beam on the polarization hologram element 209 is asymmetric with respect to the Y axis shown in FIG. 3 due to the deflection along the disc diameter of the object lens 205 (deflection with respect to light intensity distribution), thus resulting in offsets in the signal MTE obtained by Expression 8 and the signal STE obtained by Expression 9. Then, the offset coefficients (gradients) δ and ε corresponding to the deflections occurring in the signal MTE and the signal STE, respectively, are detected, and the TE signal calculation circuit 503 obtains α, which is the deflection correction coefficient, based on the ratio between the offset coefficients δ and ε as shown in Expression 11 below. Then, the tracking error signal TE is calculated based on Expression 10 and output to the signal calculation circuit 505.

α=ε/δ Expression 11

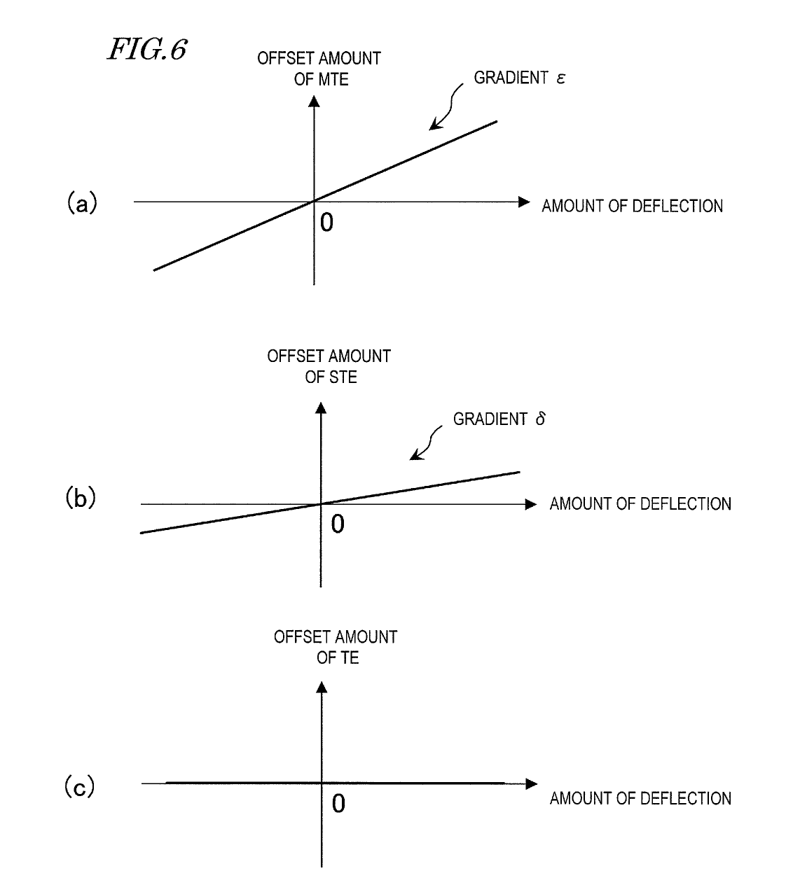

FIG. 6 are graphs showing the concept of how the offset amounts of the signals MTE, STE and TE change when the object lens 205 is deflected in the disc radial direction of the optical disc 206. FIG. 6(a) is for the signal MTE obtained by Expression 8, and FIG. 6(b) is for the signal STE obtained by Expression 9. The horizontal axis is the amount of deflection of the object lens 205 in the radial direction, and the vertical axis is the offset amount of the signal. As is clear from FIG. 6, by performing the calculation of Expression 10 (applying the deflection correction coefficient a obtained by Expression 11 to the signal MTE, and subtracting the amplified signal from the signal STE), it is possible to cancel the offset of the tracking error signal TE due to the deflection of the object lens 205 as shown in FIG. 6C, thus preventing an off-track from occurring while performing a tracking control.

The signal calculation circuit 505 outputs signals obtained by Expressions 6-11 above, and outputs the obtained signals to the object lens driving device control circuit 101 shown in FIG. 1. The object lens driving device control circuit 101 controls and drives the object lens driving device 102 by using the signals output from the signal calculation circuit 505 so as to perform focusing control and tracking control operations of moving the object lens 205 in the thickness direction and the radial direction of the optical disc 206.

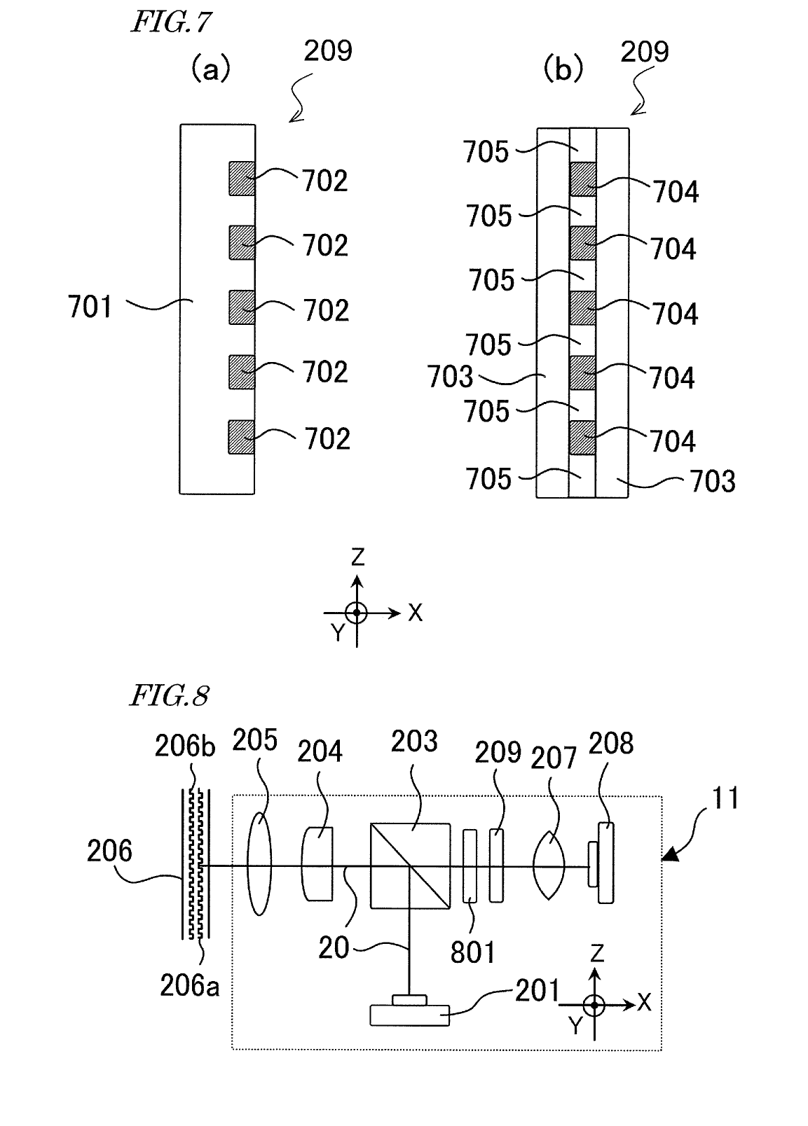

FIG. 7(a) shows a schematic cross-sectional view of the polarization hologram element 209. A lithium niobate substrate 701 is birefringent, and the crystal axis representing the optical anisotropy thereof is set in a predetermined direction. A plurality of proton exchange regions 702 extending in the Y-axis direction are provided on the lithium niobate substrate 701. The plurality of proton exchange regions 702 are provided at regular intervals in the Z-axis direction. The polarization hologram element 209 serves as a diffraction grating for diffracting light by generating a phase difference between light passing through the lithium niobate substrate 701 and light passing through the proton exchange regions 702. Moreover, by setting the thickness of the lithium niobate substrate 701 and the depth of the proton exchange regions 702 to appropriate values, the ratio between the diffraction efficiency of light (normal light) having a polarization component in a direction along the crystal axis representing the optical anisotropy and that of light (abnormal light) having a polarization component orthogonal thereto can be set to an intended value. Then, the polarization direction of the 0^{th}-order diffracted light of the normal light and that of the 1^{st}-order diffracted light of the abnormal light are orthogonal to each other.

In the present embodiment, the crystal axis representing the optical anisotropy of the lithium niobate substrate 701 is set in a direction along the Y axis in the figure so that the phase difference generated by the diffraction grating function of the polarization hologram element 209 is zero for light (normal light) having a polarization component in a direction along the Y axis in FIG. 2 and is a predetermined non-zero value for light (abnormal light) having a polarization component along the Z axis orthogonal thereto. Therefore, a component of light incident upon the polarization hologram element 209 that has a polarization direction along the Y axis is incident upon the photodetector 208 as 0^{th}-order diffracted light that is to be transmitted without being diffracted, and a component thereof that has a polarization direction along the Z axis orthogonal thereto is diffracted and incident thereupon as 1^{st}-order diffracted light.

That is, the phase difference generated between normal light and abnormal light incident upon the polarization hologram element 209 is set so that the light intensity of the 0^{th}-order diffracted light incident upon the photodetector 208 which has a polarization direction along the Y axis and the light intensity of the 1^{st}-order diffracted light which has a polarization direction in the Z-axis direction orthogonal thereto are set to intended values, respectively.

Since light emitted from a semiconductor laser as the laser light source 201 has a predetermined polarization direction, light that has been reflected by the optical disc 206 and is incident upon the polarization hologram element 209 has a normal light component and an abnormal light component for the polarization hologram, and is incident upon the photodetector 208 as 0^{th}-order diffracted light and 1^{st}-order diffracted light having light intensities that are set as described above.

Note that when the focus is on the first information recording layer 206a as described above, there is at the same time light that passes through the first information recording layer 206a to be incident upon and reflected by the second information recording layer 206b in a defocused state, and this light passes through the object lens 205 and the beam splitter 203 to be incident upon the polarization hologram element 209.

Also for the light that is reflected by the second information recording layer 206b and is incident upon the polarization hologram element 209 in a defocused state, a component thereof that has a polarization direction along the Y axis is incident upon the photodetector 208 as 0^{th}-order diffracted light that is to be transmitted without being diffracted, and a component thereof that has a polarization direction along the Z axis orthogonal to the Y axis is diffracted and is incident thereupon as 1^{st}-order diffracted light.

That is, of these reflected light beams from the second information recording layer 206b, the 0^{th}-order diffracted light through the region 300 of the polarization hologram element 209 is incident upon the photodetector 208 as a light spot 410, while the 1^{st}-order diffracted light beams through the regions 30a, 30b, 30c, 30d, 30e and 30f are incident upon the photodetector 208 as light spots 42a, 42b, 42c, 42d, 42e and 42f, respectively, as indicated by chain lines in FIG. 4A.

Then, as with reflected light from the first information recording layer 206a, the 0^{th}-order diffracted light has a polarization direction along the Y axis and the 1^{st}-order diffracted light has a polarization direction along the Z axis.

With reference to FIG. 4A, the light spot 410 is incident on the photodetector 208 in a defocused state, and is therefore incident upon all of the photodetection sections 40a, 40b, 40c, 40d, 40e, 40f, 40g and 40h of the photodetector 208. In a case where there are a plurality of light beams having different polarization directions, light beams having an equal polarization direction interfere with each other. If there is this interference between light beams, there occurs superposition of light intensities depending on the phases of the light beams at the point of observation. That is, their light intensities add up together if they are in phase, for example, and their light intensities are canceled out by each other if they are in reverse phases, resulting in an increase/decrease of light intensity.

However, with the optical pickup device of the present embodiment, the polarization directions of the 0^{th}-order diffracted light and the 1^{st}-order diffracted light through the polarization hologram element 209 are the Y-axis direction and the Z-axis direction, respectively, as described above, and are orthogonal to each other. Therefore, the light spots 41a, 41b, 41ef and 41cd incident upon the photodetection sections 40e, 40f, 40g and 40h which are 1^{st}-order diffracted light beams through the polarization hologram element 209 of the reflected light from the first information recording layer 206a in FIG. 4A do not optically interfere with the light spot 410 which is the 0^{th}-order diffracted light through the polarization hologram element 209 of the reflected light from the second information recording layer 206b.

On the other hand, optical interference occurs between the light spot 400 which is the 0^{th}-order diffracted light through the polarization hologram element 209 of the reflected light from the first information recording layer 206a which is incident upon the photodetection sections 40a, 40b, 40c and 40d, and the light spot 410 which is the 0^{th}-order diffracted light through the polarization hologram element 209 of the reflected light from the second information recording layer 206b, because their polarization directions are both in the Y-axis direction and therefore are parallel to each other.

Light that is emitted from a semiconductor laser which forms the laser light source 201 typically has a continuous light intensity distribution such that the light intensity, highest at the center, gradually decreases away from the center. Also for the light intensity distributions of the 0^{th}-order diffracted light and the 1^{st}-order diffracted light, which are produced by the polarization hologram element 209 after light beams are condensed onto and reflected by the optical disc 206, the continuities are maintained, thereby allowing for a stable control using TE and FE produced based on Expressions 6-11 by using the 0^{th}-order diffracted light and the 1^{st}-order diffracted light having continuous light intensity distributions.

Therefore, no optical interference occurs between portions of the light spot 410 to be incident upon the photodetection sections 40e, 40f, 40g and 40h, which are 0^{th}-order diffracted light beams, and the light spots 41a, 41b, 41ef and 41cd which are 1^{st}-order diffracted light beams, resulting in no increase/decrease of light intensity. Thus, the continuities of the light intensity distributions of the light spots 41a, 41b, 41ef and 41cd are maintained, and appropriate MTE, STE and TE signals are obtained from Expressions 8-11.

With the optical pickup device 100 of the present embodiment, 0^{th}-order diffracted light and 1^{st}-order diffracted light whose polarization directions are orthogonal to each other are produced by using the polarization hologram element 209. Therefore, as compared with the configuration disclosed in Japanese Laid-Open Patent Publication No. 2009-009628 in which a ½-wave plate is added between a diffraction element and a photodetector, the number of optical elements can be reduced and it is possible to reduce the size and the thickness of the optical pickup device 100. Since the number of optical elements is small, the step of aligning optical elements with one another in the manufacturing process is facilitated, thereby allowing for a reduction in the manufacturing cost.

As compared with the configuration where the reflected light is diffracted both through the diffraction element and the ½-wave plate, there is only a single diffraction through the polarization hologram element 209, and it is therefore possible to reduce the extent over which the reflected light spreads out. Thus, it is possible to reduce the size of the detection lens 207 and the photodetector 208 downstream along the path, and therefore to reduce the size and the thickness of the optical pickup device 100.

It is preferred that the polarization hologram element 209 is placed closer to an adjacent downstream optical element than to an adjacent upstream optical element along the optical path (return path). In the example shown in FIG. 2, the polarization hologram element 209 is preferably placed closer to the detection lens 207 than to the beam splitter 203. More specifically, where the distance from a base point (the position of the detection lens 207) to the beam splitter 203 is assumed to be 1, the distance from the base point to the polarization hologram element 209 is preferably ¼ or more and less than ½. Then, the reflected light having passed through the polarization hologram element 209 can be made incident upon the detection lens 207 while the degree of spreading thereof is controlled, thereby allowing for a further reduction in the size of the detection lens 207 and the photodetector 208.

Note that optical interference occurs between the light spot 400 which is the 0^{th}-order diffracted light through the polarization hologram element 209 of the reflected light from the first information recording layer 206a and the light spot 410 which is the 0^{th}-order diffracted light through the polarization hologram element 209 of the reflected light from the second information recording layer 206b.

However, since the light spot 410 formed by the reflected light from the second information recording layer 206b is defocused to be incident upon the photodetection sections 40a, 40b, 40c and 40d, the light intensity thereof is sufficiently small with respect to the light intensity of the light spot 400 formed by the reflected light from the first information recording layer 206a, and the degree of the increase/decrease of light intensity due to interference between these light beams on the photodetection sections 40a, 40b, 40c and 40d is sufficiently small. Therefore, it has only a small influence on the continuity of the light intensity distribution of the light spot 400, and appropriate FE and RF signals are obtained from Expressions 6 and 7.

Note that although the light spots 42a, 42b, 42c, 42d, 42e and 42f which are 1^{st}-order diffracted light beams through a diffraction element 202 of the reflected light from the second information recording layer 206b are also incident upon the photodetector 208, the settings are such that they are incident upon positions distant from the photodetection sections 40a, 40b, 40c, 40d, 40e, 40f, 40g and 40h as shown in FIG. 4A and are not incident upon these photodetection sections. Therefore, they have no influence on the FE, TE and RF signals obtained from Expressions 6-11.

With such a configuration as described above, when recording/reproducing an optical disc having a plurality of information recording layers, the influence of stray light from an information recording layer that is different from the information recording layer being recorded/reproduced can be reduced, and it is possible to stably detect the tracking signal and the focus error signal, thus realizing desirable recording/reproducing capability.

Note that while the configuration shown in FIGS. 2 to 4B has been described in the present embodiment for the configuration of the optical system and the detector, similar effects can be obtained with other configurations, and the present invention is not limited to the configuration of the optical pickup device of the present embodiment.

Moreover, while the TE main signal MTE is obtained based on Expression 8 in the optical pickup device of the present embodiment, the tracking error signal TE may be produced by using Expressions 10-12 based on Expression 12 below, using outputs from the photodetection sections 40a, 40b, 40c and 40d.

MTE=(C+D)−(A+B) Expression 12

Since the signal produced by Expression 12 is a tracking error signal obtained by a known push-pull method, an appropriate tracking error signal TE can be obtained based on Expression 10.

The TE main signal MTE may be produced as shown in Expression 13 below.

MTE={(C+D)−(A+B)}+(E−F) Expression 13

Since Expressions 8 and 12 are both a tracking error signal obtained by a known push-pull method as described above, the output of the obtained MTE signal is larger than that of each of the individual signals obtained by Expressions 8 and 12, and it is possible to obtain an even more stable tracking error signal TE by Expressions 9, 10 and 13.

Note that the circuits used in the optical pickup device of the present embodiment are illustrative, and the circuit configuration is not limited to that of the embodiment of the present invention. For example, the object lens driving device control circuit 101 may include the function of the object lens driving circuit 102.

In the present embodiment, the calculation circuits for calculating the signals obtained from an optical disc may be provided in the optical disc device, and the configuration is not limited to that of the embodiment of the present invention.

A configuration for setting the light intensity ratio between the 0^{th}-order diffracted light and the 1^{st}-order diffracted light obtained through the polarization hologram element 209 in the present embodiment will be further described below.

As described above, the phase difference generated between the incident normal light and the incident abnormal light using the diffraction grating function of the polarization hologram element 209 is set so that the light intensity of the 0^{th}-order diffracted light incident upon the photodetector 208 which has a polarization direction along the Y axis and the light intensity of the 1^{st}-order diffracted light which has a polarization direction in the Z-axis direction orthogonal thereto are set to intended values, respectively.

Therefore, the light intensity ratio between the 0^{th}-order diffracted light and the 1^{st}-order diffracted light can be adjusted by adjusting the light intensity ratio between normal light and abnormal light for the light at the point of incidence upon the polarization hologram element 209.

For this, the laser light source 201 (FIG. 2) is rotated about an optical axis 20 of the optical system 10 (the direction along the Z axis) as the central axis. In this case, the rotation angle of the laser light source 201 is set so that the light intensity ratio between normal light and abnormal light (for the light emitted from the laser light source 201, reflected by the beam splitter 203, incident upon the optical disc 206, reflected by the optical disc, and incident upon the polarization hologram element 209) is set to be different from the ratio when the laser light source 201 is not rotated. Thus, the adjustment and the setting of the light intensity ratio between the 0^{th}-order diffracted light and the 1^{st}-order diffracted light detected by the photodetector 208 can be done.

Referring to FIG. 5, the polarization direction of the emitted light when the laser light source 201 is rotated will be described.

First, a polarization direction 201a of emitted light when the laser light source 201 is not rotated will be described. In this case, the polarization direction 201a of light emitted from the laser light source 201 is along the Y axis and is parallel to a surface 203a of the beam splitter 203 on the optical disc 206 side on the optical path. The surface 203a of the beam splitter 203 is a reflection surface for reflecting the light emitted from the laser light source 201 so as to change the optical path direction, and is a surface parallel to the Y-axis direction in the figure. The Y-axis direction is a direction that is perpendicular to the optical axis direction (the Z-axis direction) of light from the laser light source 201 incident upon the beam splitter 203, and is perpendicular to the optical axis direction (the X-axis direction) of light reflected by the beam splitter 203.

Then, the majority of light that is incident upon and reflected by the optical disc 206 to be incident upon the polarization hologram element 209 is normal light whose polarization direction is along the Y axis. The normal light, which accounts for the majority of the light, is incident upon the photodetector 208 as 0^{th}-order diffracted light that is to be transmitted without being diffracted, and the abnormal light whose polarization direction is along the Z axis orthogonal to the Y axis is diffracted and incident upon the photodetector 208 as 1^{st}-order diffracted light.

Where the laser light source 201 is rotated, a polarization direction 201b of the light emitted from the laser light source 201 is inclined with respect to the surface 203a of the beam splitter 203. For example, where the laser light source 201 is rotated by an angle θ, the polarization direction 201b is inclined by the angle θ with respect to the polarization direction 201a and is also inclined by the angle θ with respect to the surface 203a parallel to the polarization direction 201a. For example, the angle θ is an angle of 5° or more and 10° or less. Then, the ratio between the component parallel to the surface 203a and the component perpendicular thereto changes, and the ratio between the normal light whose polarization direction is along the Y axis and the abnormal light whose polarization direction is along the Z axis orthogonal to the Y axis (of the light that is incident upon and reflected by the optical disc 206 to be incident upon the polarization hologram element 209) changes.

Thus, with such a configuration, the magnitude of the signal produced based on Expressions 6-11 can be set appropriately. For example, it is possible to achieve such a setting that it is possible to obtain both a sufficient light intensity of 0^{th}-order diffracted light needed to produce the focus error signal FE by Expression 6 and the information signal RF by Expression 7, and a sufficient light intensity of 1^{st}-order diffracted light needed to produce the tracking error signal (TE) by Expressions 8-11. For example, it is possible to achieve such a setting that the ratio between 0^{th}-order diffracted light and 1^{st}-order diffracted light is 10:1, making it possible to detect a good-quality signal.

Therefore, it is possible to realize an optical pickup device with a stable tracking and focusing control and desirable recording/reproducing capability. While it is difficult to adjust positions of optical elements after the optical pickup device is assembled, it is easy to rotate the light source. Therefore, it is easy to make fine adjustments to the light intensity ratio and to realize a stable tracking and focusing control with low cost and desirable recording/reproducing capability.

As a configuration for controlling the polarization direction of light incident upon the polarization hologram element 209 and setting the light intensity ratio between 0^{th}-order diffracted light and 1^{st}-order diffracted light, it is possible to employ a configuration using an optical system 11 including a ½-wave plate 801 added to the optical system 10, wherein reflected light from the optical disc 206 is allowed to be incident upon the ½-wave plate 801, as shown in FIG. 8.

Then, the reflected light from the optical disc 206 passes through the ½-wave plate 801 and is incident upon the polarization hologram element 209. The ½-wave plate 801 has such a configuration that the polarization direction of the incident light is rotated by a predetermined angle about the optical axis 20 (the direction along the X axis) as the central axis, and based on the setting of the angle of rotation, it is possible to set, to an intended value, the light intensity ratio between normal light and abnormal light incident upon the polarization hologram element 209 for light that is reflected by the optical disc 206 to pass through the ½-wave plate 801, thus making it possible to set the light intensity ratio between 0^{th}-order diffracted light and 1^{st}-order diffracted light detected by the photodetector 208 to an intended value.

Therefore, with such a configuration, it is possible to appropriately set the magnitude of the signal produced based on Expressions 6-11 and to detect a good-quality signal, thereby realizing an optical pickup device with a stable tracking and focusing control and desirable recording/reproducing capability.

Note that although the embodiment of the present invention shown in FIG. 8 is directed to a configuration where the ½-wave plate 801 is placed between the beam splitter 203 and the polarization hologram element 209, the present invention is not limited to the configuration shown in FIG. 8, and the ½-wave plate 801 may be placed on an optical path extending from the laser light source 201 to the optical disc 206, or on an optical path extending from the optical disc 206 to the polarization hologram element 209.

Moreover, in FIG. 8, the ½-wave plate 801 and the polarization hologram element 209 may be provided as an integral component, which is advantageous for reducing the size and cost of the pickup device by reducing the number of components.

A configuration as follows may also be usable for setting the light intensity ratio between 0^{th}-order diffracted light and 1^{st}-order diffracted light. A case will now be described where the crystal axis direction representing the optical anisotropy of the lithium niobate substrate 701 is set with a predetermined angle from the Y axis in the ZY plane, with respect to the diffraction grating function set in a direction along the Y axis in FIG. 2 which is set in the polarization hologram element 209 of the present embodiment.

In this case, a component of the light incident upon the polarization hologram element 209 whose polarization direction is along the crystal axis representing the optical anisotropy is the normal light whereas a component thereof whose polarization direction is in a direction perpendicular thereto is the abnormal light, and the diffraction grating function causes phase differences of zero and a predetermined non-zero value for the normal light and the abnormal light, respectively, wherein the normal light is not diffracted through the polarization hologram element 209 to be 0^{th}-order diffracted light and the abnormal light is diffracted therethrough to be 1^{st}-order diffracted light.

Therefore, by setting a predetermined angle for the grating for the diffraction grating function of the polarization hologram element 209, it is possible to set, to a predetermined value, the ratio between the normal light and the abnormal light for light that is emitted from the laser light source 201, reflected by the optical disc 206 and then incident upon the polarization hologram element 209, thereby making it possible to set the light intensity ratio between the 0^{th}-order diffracted light and the 1^{st}-order diffracted light to be detected by the photodetector 208.

Therefore, with such a configuration, it is possible to appropriately set the magnitude of the signal produced based on Expressions 6-11 and to detect a good-quality signal, thereby realizing an optical pickup device with a stable tracking and focusing control and desirable recording/reproducing capability.

Note that it is also possible to use a configuration where the light intensity ratio between the 0^{th}-order diffracted light and the 1^{st}-order diffracted light through the polarization hologram element 209 is set by a combination of the configurations described above, and similar effects will be provided.

Moreover, by using the configuration described above, the ratio between the 0^{th}-order diffracted light and the 1^{st}-order diffracted light through the polarization hologram element 209 may be switched from one to another depending on the operation. An example is a case where the ratio between the 0^{th}-order diffracted light and the 1^{st}-order diffracted light is switched from one to another when an optical disc is reproduced and when it is recorded.

Typically, when reproducing an optical disc, a large light intensity is needed for 0^{th}-order diffracted light which is to be the information signal, and it is therefore possible to realize desirable reproducing capability by setting the light intensity ratio to be large for the 0^{th}-order diffracted light during a reproducing operation. When recording, on the other hand, it is possible to increase the magnitude of the tracking error signal produced by Expressions 8-11 by setting the light intensity ratio to be large for the 1^{st}-order diffracted light, thereby enabling a control while reducing the amount of off-track which is more important during a recording operation, thus obtaining more desirable recording capability.

For example, the optical pickup device 100 may include a switching section (polarization control section) 210 for rotating the laser light source 201. The switching section 210 includes an arbitrary driving section such as a magnetic coil or a piezoelectric member for rotating the laser light source 201. By rotating the laser light source 201, it is possible to switch the angle between the polarization direction of the light emitted from the laser light source 201 and the direction of the surface 203a of the beam splitter 203 that is closer to the optical disc 206 on the optical path. By rotating the laser light source 201 so that the angle is larger during a recording operation than during a reproducing operation, it is possible to increase the light intensity ratio for the 1^{st}-order diffracted light. By decreasing the angle during a reproducing operation, it is possible to increase the light intensity ratio for the 0^{th}-order diffracted light. For example, by setting the angle θ in a range from 5° to 10° during a recording operation as opposed to setting the angle θ (FIG. 5) to 0° during a reproducing operation, it is possible to obtain an appropriate light intensity ratio.

Therefore, with such a configuration, it is possible to realize more desirable recording/reproducing capability.

Note that the polarization hologram element 209 may have a configuration in which birefringent layers 704 and transparent layers 705 extending in a direction along the Y axis and provided at regular intervals in a direction along the Z axis are sandwiched between transparent substrates 703, as shown in the schematic cross-sectional view of FIG. 7(b), the configuration serving as a diffraction grating for diffracting light by producing a phase difference between light passing through the birefringent layer 704 and light passing through the transparent layer 705.

In this case, the transparent substrate 703 is made of a glass, or the like, the birefringent layer 704 is made of a macromolecular material such as a liquid crystal material, for example, and the transparent layer 705 is made of a material which is optically isotropic. The cost is lower as compared with a liquid crystal material such as the lithium niobate substrate 701, and the birefringence of a liquid crystal material can be controlled relatively easily and such a material is suitable for mass production, thereby providing advantages for reducing the cost of an optical pickup device.

Moreover, by setting the optically-anisotropic axis direction of the birefringent layer 704 with a predetermined angle with respect to the grating for the diffraction grating function which is set in a direction along the Y axis in FIG. 2, it is possible to set the ratio between normal light and abnormal light for the light incident upon the polarization hologram element 209 to a predetermined value, thereby making it possible to set the light intensity ratio between the 0^{th}-order diffracted light and the 1^{st}-order diffracted light to be detected by the photodetector 208.

While the effect of the present invention for the reflected light from the second recording layer has been described in the present embodiment, the effect of the present invention is similar for the reflected light from the surface of an optical disc, in which case it is possible to realize desirable recording/reproducing capability with either an optical disc having a single recording layer or an optical disc having a plurality of recording layers.

### Embodiment 2

Embodiment 2 will now be described with reference to FIGS. 1 to 9. Note that in FIGS. 1 to 8, like elements to those of Embodiment 1 are denoted by like reference numerals.

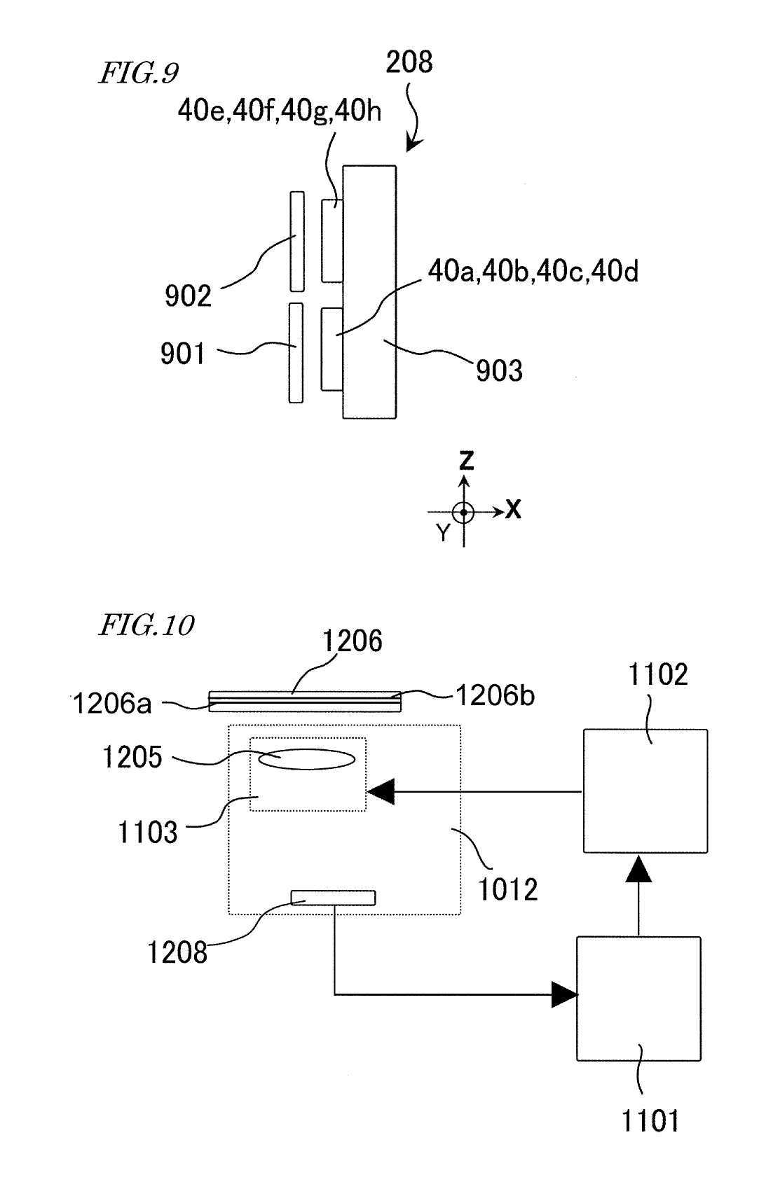

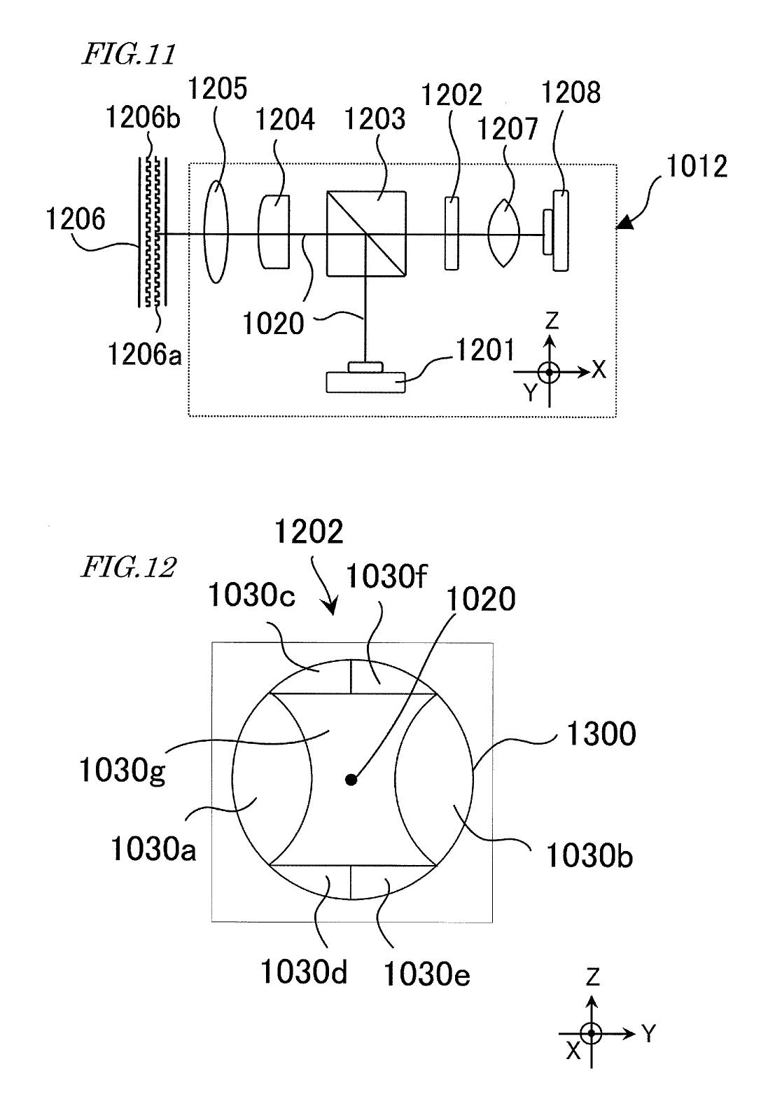

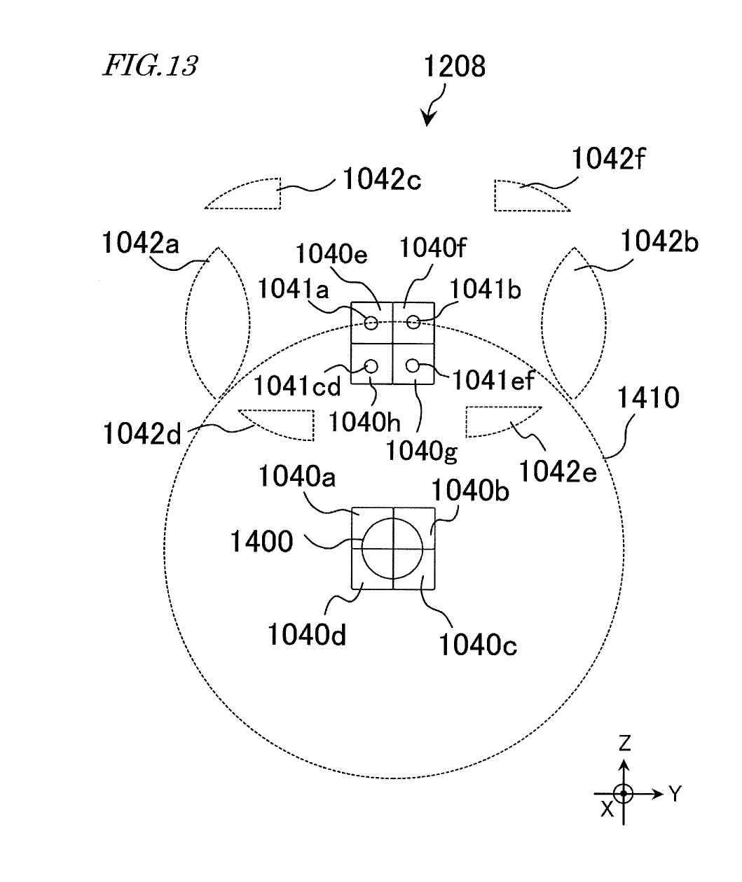

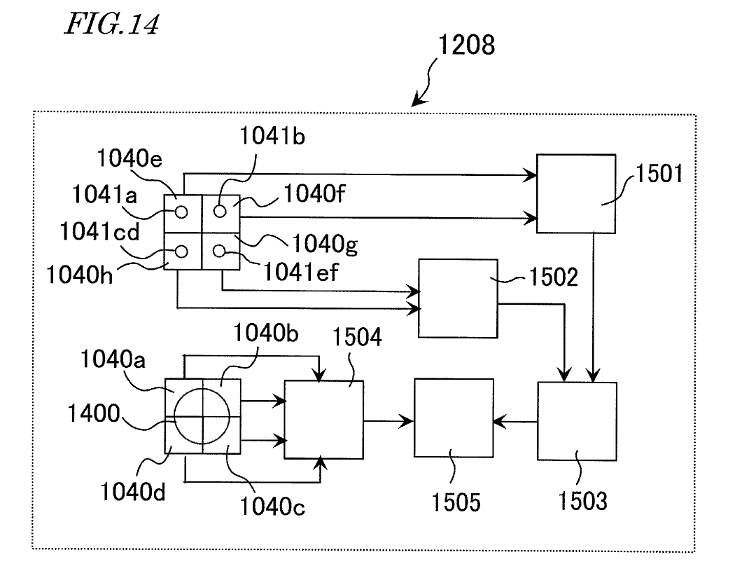

The present embodiment is a configuration in which the photodetector 208 shown in FIG. 9 is used in Embodiment 1.

Referring to a side view as seen from the XZ plane of FIG. 9, the photodetector 208 includes the photodetection sections 40a, 40b, 40c, 40d, 40e, 40f, 40g and 40h on a photodetector substrate 903 not shown in FIG. 4A, and further includes a first analyzer 901 and a second analyzer 902. The first analyzer 901 serves to allow only light beams whose polarization direction is along the Y axis in the figure to pass therethrough among the light beams incident upon the photodetection sections 40a, 40b, 40c and 40d, and the second analyzer 902 serves to allow only light beams whose polarization direction is along the Z axis in the figure to pass therethrough among the light beams incident upon the photodetection sections 40e, 40f, 40g and 40h.

FIG. 7(a) shows a schematic cross-sectional view of the polarization hologram element 209 including the proton exchange regions 702 extending in the Y axis and provided at regular intervals in a direction along the Z axis on the lithium niobate substrate 701 being birefringent and having the crystal axis representing the optical anisotropy set in a predetermined direction. The polarization hologram element 209 serves as a diffraction grating for diffracting light by producing a phase difference between light passing through the lithium niobate substrate 701 and light passing through the proton exchange region 702. By setting the thickness of the lithium niobate substrate 701 and the depth of the proton exchange regions 702 to appropriate values, it is possible to set, to an intended value, the diffraction efficiency ratio between light (normal light) having a polarization component in a direction along the crystal axis representing the optical anisotropy and light (abnormal light) having a polarization component orthogonal thereto. Then, the polarization direction of the 0^{th}-order diffracted light of the normal light and that of the 1^{st}-order diffracted light of the abnormal light are orthogonal to each other.

Then, in the present embodiment, the crystal axis representing the optical anisotropy of the lithium niobate substrate 701 is set in a direction along the Y axis in the figure, and the phase difference caused by the diffraction grating function of the polarization hologram element 209 is set so that it is zero for light (normal light) having a polarization component in a direction along the Y axis in FIG. 2 and is a predetermined non-zero value for light (abnormal light) having a polarization component along the Z axis orthogonal thereto. Therefore, a component of light incident upon the polarization hologram element 209 that has a polarization direction along the Y axis is incident upon the photodetector 208 as 0^{th}-order diffracted light that is transmitted without being diffracted, and a component thereof that has a polarization direction along the Z axis orthogonal thereto is diffracted to be incident thereupon as 1^{st}-order diffracted light.

Since the light emitted from a semiconductor laser as the laser light source 201 has a predetermined polarization direction, the light that is reflected by the optical disc 206 to be incident upon the polarization hologram element 209 includes a normal light component and an abnormal light component for a polarization hologram, and the light is incident upon the photodetector 208 as 0^{th}-order diffracted light and 1^{st}-order diffracted light having light intensities which are set as described above. As described above, where the focus is on the first information recording layer 206a, there is at the same time light that passes through the first information recording layer 206a to be incident upon and reflected by the second information recording layer 206b in a defocused state, and this light passes through the object lens 205 and the beam splitter 203 to be incident upon the polarization hologram element 209.

As described above, where the focus is on the first information recording layer 206a, there is at the same time light that passes through the first information recording layer 206a to be incident upon and reflected by the second information recording layer 206b in a defocused state, and this light passes through the object lens 205 and the beam splitter 203 to be incident upon the polarization hologram element 209. However, as with the reflected light from the first information recording layer 206a, the 0^{th}-order diffracted light through the polarization hologram element 209 of the reflected light from the second information recording layer 206b has a polarization direction along the Y axis and the 1^{st}-order diffracted light has a polarization direction along the Z axis.

Referring to FIG. 4A, the light spot 410 which is 0^{th}-order diffracted light through the polarization hologram element 209 of the reflected light from the second information recording layer 206b is incident upon the photodetector 208 in a defocused state so as to travel to all of the photodetection sections 40a, 40b, 40c, 40d, 40e, 40f, 40g and 40h of the photodetector 208. However, since the light spot 410 has a polarization direction along the Y axis, it cannot pass through the second analyzer 902 in FIG. 9 so that it is not incident upon the photodetection sections 40e, 40f, 40g and 40h and is incident only upon the photodetection sections 40a, 40b, 40c and 40d.

Therefore, the reflected light from the second information recording layer 206b is not incident upon the photodetection sections 40e, 40f, 40g and 40h, and only the light spots 41a, 41b, 41cd and 41ef, which are 1^{st}-order diffracted light through the polarization hologram element 209 of the reflected light from the first information recording layer 206a, are incident thereupon, thereby obtaining an appropriate STE signal by Expression 9.

On the other hand, the light spot 400 which is 0^{th}-order diffracted light through the polarization hologram element 209 of the reflected light from the first information recording layer 206a to be incident upon the photodetection sections 40a, 40b, 40c and 40d, and the light spot 410 which is 0^{th}-order diffracted light through the polarization hologram element 209 of the reflected light from the second information recording layer 206b both have a polarization direction in the Y-axis direction, and therefore pass through the first analyzer 901. Optical interference occurs therebetween because the polarization directions are parallel to each other.

However, since the light spot 410 formed by the reflected light from the second information recording layer 206b is defocused to be incident upon the photodetection sections 40a, 40b, 40c and 40d, the light intensity thereof is sufficiently small with respect to the light intensity of the light spot 400 formed by the reflected light from the first information recording layer 206a, and the degree of the increase/decrease of light intensity due to interference between these light beams on the photodetection sections 40a, 40b, 40c and 40d is sufficiently small. Therefore, it has only a small influence on the continuity of the light intensity distribution of the light spot 400, and appropriate FE and RF signals are obtained from Expressions 6 and 7.

Note that although the light spots 42a, 42b, 42c, 42d, 42e and 42f which are 1^{st}-order diffracted light through the polarization hologram element 209 of the reflected light from the second information recording layer 206b are also incident upon the photodetector 208 in the present embodiment, the setting is such that they are incident upon positions distant from the photodetection sections 40a, 40b, 40c, 40d, 40e, 40f, 40g and 40h as shown in FIG. 4A and are not incident upon these photodetection sections. Therefore, they have no influence on the FE, TE and RF signals obtained from Expressions 6-11.

However, even if the light spots 42a, 42b, 42c and 42d which are 1^{st}-order diffracted light through the polarization hologram element 209 of the reflected light from the second information recording layer 206b are incident upon the photodetection sections 40a, 40b, 40c and 40d due to attachment errors, adjustment errors, etc., of components of the optical system 10, the light spots 42a, 42b, 42c and 42d whose polarization direction is along the Z axis cannot pass through the first analyzer, thereby obtaining appropriate FE and RF signals.

As described above, by having the polarization direction of 0^{th}-order diffracted light through the polarization hologram element 209 and the polarization direction of 1^{st}-order diffracted light therethrough orthogonal to each other, the 0^{th}-order diffracted light and the 1^{st}-order diffracted light through the polarization hologram element 209 can be optically separated from each other using the first and second analyzers and made to be incident upon the respective photodetection sections. Therefore, when recording/reproducing an optical disc having a plurality of information recording layers, the influence of stray light from an information recording layer that is different from the information recording layer being recorded/reproduced can be reduced, and it is possible to even more stably detect the tracking signal and the focus error signal, thus realizing desirable recording/reproducing capability.

Note that the optical pickup device of the present embodiment may have a configuration where the first analyzer 901 is not provided, and the photodetector 208 is only provided with the second analyzer 902.

As described above, even if the light spots 42a, 42b, 42c and 42d which are 1^{st}-order diffracted light through the polarization hologram element 209 of the reflected light from the second information recording layer 206b are incident upon the photodetection sections 40a, 40b, 40c and 40d due to attachment errors, adjustment errors, etc., of components of the optical system 10, the light spots 40a, 40b, 40c and 40d which are 0^{th}-order diffracted light through the polarization hologram element 209 of the reflected light from the first information recording layer 206a have a polarization direction in a direction along the Y axis and do not optically interfere with the light spots 42a, 42b, 42c and 42d having a polarization direction in a direction along the Z axis, thereby obtaining appropriate FE and RF signals.

Although the present embodiment is directed to a case where the photodetector 208 includes the first analyzer 901 and the second analyzer 902, similar effects are obtained when the first analyzer 901 and the second analyzer 902 may be provided between the detection lens 207 and the photodetector 208 instead of being provided on the photodetector 208.

Note that while the configuration shown in FIGS. 2 to 4B and 9 has been described in the present embodiment for the configuration of the optical system and the detector, the present invention is not limited to the configuration above, and appropriate modifications can be made thereto.

The circuits used in the optical pickup device of the present embodiment are illustrative, and the circuit configuration is not limited to that of the present embodiment. For example, the object lens driving device control circuit 101 may include the function of the object lens driving circuit 102.

In the present embodiment, the calculation circuits for calculating the signals obtained from an optical disc may be provided in the optical disc device, and the configuration is not limited to that of the present embodiment.

Moreover, in a case where the laser light source 201 shown in FIG. 2 is rotated about the optical axis 20 of the optical system 10 (the direction along the Z axis) as the central axis, so as to set, to an intended value, the light intensity ratio between normal light and abnormal light for light that is emitted from the laser light source 201, reflected by the optical disc and incident upon the polarization hologram element 209 based on the setting of the angle of rotation, and set the light intensity ratio between the 0^{th}-order diffracted light and the 1^{st}-order diffracted light detected by the photodetector 208, it is possible to appropriately set the magnitude of the signal produced based on Expressions 6-11 and to detect a good-quality signal, thereby realizing an optical pickup device with a stable tracking and focusing control and desirable recording/reproducing capability.

Where a configuration using the optical system 11 including the ½-wave plate 801 for rotating the polarization direction of the incident light by a predetermined angle about the optical axis 20 as the central axis added to the optical system 10 shown in FIG. 8 wherein the reflected light from the optical disc 206 is incident upon the ½-wave plate 801 is used as the configuration for controlling the polarization direction of light incident upon the polarization hologram element 209 and setting the light intensity ratio between 0^{th}-order diffracted light and 1^{st}-order diffracted light, it is possible to set the light intensity ratio between the 0^{th}-order diffracted light and the 1^{st}-order diffracted light detected by the photodetector 208 to an intended ratio, and it is possible to appropriately set the magnitude of the signal produced based on Expressions 6-11 and to detect a good-quality signal, thereby realizing an optical pickup device with a stable tracking and focusing control and desirable recording/reproducing capability.

Moreover, in a case where the configuration for setting the light intensity ratio between 0^{th}-order diffracted light and 1^{st}-order diffracted light is a configuration where the crystal axis direction representing the optical anisotropy of the lithium niobate substrate 701 is set with a predetermined angle from the Y axis in the ZY plane, with respect to the diffraction grating function set in a direction along the Y axis in FIG. 2 which is set in the polarization hologram element 209, the ratio between normal light and abnormal light for light that is emitted from the laser light source 201, reflected by the optical disc 206 and then incident upon the polarization hologram element 209 can be set to a predetermined value, making it possible to set the light intensity ratio between the 0^{th}-order diffracted light and the 1^{st}-order diffracted light detected by the photodetector 208. Therefore, it is possible to appropriately set the magnitude of the signal produced based on Expressions 6-11 and to detect a good-quality signal, thereby realizing an optical pickup device with a stable tracking and focusing control and desirable recording/reproducing capability.

Note that it is also possible to use a configuration where the light intensity ratio between the 0th-order diffracted light and the 1st-order diffracted light through the polarization hologram element 209 is set by a combination of the configurations described above, and similar effects will be provided.

Moreover, by using the configuration described above, the ratio between the 0^{th}-order diffracted light and the 1st-order diffracted light through the polarization hologram element 209 may be switched from one to another. An example is a case where the ratio between the 0^{th}-order diffracted light and the 1^{st}-order diffracted light is switched from one to another when an optical disc is reproduced and when it is recorded.

Typically, when reproducing an optical disc, a large light intensity is needed for 0th-order diffracted light which is to be the information signal, and it is therefore possible to realize desirable reproducing capability by setting the light intensity ratio to be large for the 0th-order diffracted light during a reproducing operation. When recording, on the other hand, it is possible to increase the magnitude of the tracking error signal produced by Expressions 8-11 by setting the light intensity ratio to be large for the 1st-order diffracted light, thereby enabling a control while reducing the amount of off-track which is more important during a recording operation, thus obtaining more desirable recording capability.

Note that although the TE main signal MTE is obtained from Expression 8 in the optical pickup device of the present embodiment, the tracking error signal TE may be produced by using Expressions 10-12, and the TE main signal MTE may be produced from Expression 13. Since Expressions 8 and 12 are both a tracking error signal obtained by a known push-pull method as described above, the output of the obtained MTE signal is larger than that of each of the individual signals obtained by Expressions 8 and 12, and it is possible to obtain an even more stable tracking error signal TE by Expressions 9, 10 and 13.

As in Embodiment 1, the polarization hologram element 209 may have a configuration in which the birefringent layers 704 and the transparent layers 705 extending in a direction along the Y axis and provided at regular intervals in a direction along the Z axis are sandwiched between the transparent substrates 703, as shown in the schematic cross-sectional view of FIG. 7(b), the configuration serving as a diffraction grating for diffracting light by producing a phase difference between light passing through the birefringent layer 704 and light passing through the transparent layer 705, thereby providing advantages for reducing the cost of an optical pickup device.

Moreover, by setting the optically-anisotropic axis direction of the birefringent layer 704 with a predetermined angle with respect to the grating for the diffraction grating function which is set in a direction along the Y axis in FIG. 2, it is possible to set the ratio between normal light and abnormal light for the light incident upon the polarization hologram element 209 to a predetermined value, thereby making it possible to set the light intensity ratio between the 0th-order diffracted light and the 1st-order diffracted light to be detected by the photodetector 208.

While the effect of the present invention for the reflected light from the second recording layer has been described in the present embodiment, the effect of the present invention is similar for the reflected light from the surface of an optical disc, in which case it is possible to realize desirable recording/reproducing capability with either an optical disc having a single recording layer or an optical disc having a plurality of recording layers.

As described above, the optical pickup device and the optical disc device of the present invention are particularly useful in the technical field of optically recording or reproducing information to/from an optical information recording medium such as an optical disc by using a laser light source.

What is claimed is:

1. An optical pickup device, comprising:
a light source for emitting light;
an object lens for condensing the light onto an optical disc;
a polarization hologram element for diffracting reflected light reflected by the optical disc;
a first photodetection section for detecting 0^{th}-order diffracted light produced by the diffraction; and
a second photodetection section for detecting 1^{st}-order diffracted light produced by the diffraction,
wherein the polarization hologram element diffracts the reflected light so that an optical polarization direction of the 0^{th}-order diffracted light incident upon the first photodetection section and an optical polarization direction of the 1^{st}-order diffracted light incident upon the second photodetection section are orthogonal to each other.

2. The optical pickup device according to claim 1, further comprising:
a beam splitter for changing a direction of the light emitted from the light source,
wherein a polarization direction of the light emitted from the light source and incident upon the beam splitter is inclined with respect to a surface of the beam splitter that is closer to the optical disc on an optical path.

3. The optical pickup device according to claim 1, further comprising:
a beam splitter for changing a direction of the light emitted from the light source; and
a switching section for rotating the light source so as to switch, from one to another, an angle between a polarization direction of the light emitted from the light source and incident upon the beam splitter and a direction of a surface of the beam splitter that is closer to the optical disc on an optical path.

4. The optical pickup device according to claim 3, wherein the switching section switches the angle from one to another when recording information to the optical disc and when reproducing information from the optical disc.

5. The optical pickup device according to claim 4, wherein the switching section switches the angle from one to another so that the angle during the recording operation is larger than that during the reproducing operation.

6. The optical pickup device according to claim 1, wherein the polarization hologram element is placed closer to an adjacent downstream optical element than to an adjacent upstream optical element along an optical path.

7. The optical pickup device according to claim 1, wherein the polarization hologram element includes:
a birefringent substrate; and
a diffraction grating provided on the substrate.

8. The optical pickup device according to claim 1, wherein the polarization hologram element includes a birefringent layer provided with a diffraction grating.

9. The optical pickup device according to claim 1, further comprising a diffracted light intensity ratio setting section for setting a light intensity ratio between the 0^{th}-order diffracted light and the 1^{st}-order diffracted light produced by the polarization hologram element to a predetermined value.

10. The optical pickup device according to claim 9, wherein the diffracted light intensity ratio setting section is a polarization control section for controlling polarization direction of light to be incident upon the polarization hologram element.

11. The optical pickup device according to claim 10, wherein the polarization control section is a wave plate.

12. The optical pickup device according to claim 9, wherein the diffracted light intensity ratio setting section sets a predetermined angle between an optically-anisotropic axis direction of a birefringent member of the polarization hologram element and a grating direction of a diffraction grating of the polarization hologram element.

13. The optical pickup device according to claim 1, wherein:
the first photodetection section detects the 0^{th}-order diffracted light which is incident thereupon through a first analyzer; and
the second photodetection section detects the 1^{st}-order diffracted light which is incident thereupon through a second analyzer.

14. The optical pickup device according to claim 9, wherein a light intensity ratio between the 0^{th}-order diffracted light and the 1^{st}-order diffracted light is switched between a plurality of values by using the diffracted light intensity ratio setting section.

15. An optical disc device having the optical pickup device according to claim 1, comprising:
a first calculation section for producing a focus error signal based on light received by the first photodetection section;
a second calculation section for calculating a differential output obtained from an amount of light detected by the second photodetection section so as to produce at least a portion of a tracking error signal; and
a control section for performing a focusing control and a tracking control by using the signals calculated by the first and second calculation sections.
